(19) United States
(12) Patent Application Publication
(10) Pub. No.: US 2007/0215426 A1
(43) Pub. Date: Sep. 20, 2007

(54) Universal luggage handle extender

(76) Inventor: Carey Randolph Mincey, Shreveport, LA (US)

Correspondence Address: CAREY RANDOLPH MINCEY, 1069 WATERS EDGE CIRCLE, SHREVE PORT, LA, 71106, US

(21) Appl. No.: 11/725,340

(22) Filed: Mar. 19, 2007

Related U.S. Application Data
(60) Provisional application No. 60/783,736, filed on Mar. 20, 2006.

(51) Int. Cl. A45C 13/30; A45C 13/00; A45C 13/22; B25G 1/00

(52) U.S. Cl. 190/115; 16/426

(57) ABSTRACT

This invention is a luggage handle extender that is universal to fit all Pullman type handles. A flexible strap that secures onto conventional luggage handles to give you extra room and flexibility while walking with your conventional luggage; it extends conventional luggage handles giving you extra room preventing the luggage from banging the back of your leg while walking, it also has a built in identification tag to help prevent lost or misplaced luggage. The Universal Luggage Handle Extender is flexible with its own handle and can be folded to be put in a handbag, purse, or pocket.

Applicant claims the benefit of an earlier U.S. provisional patent application No. 60783736 called the Extra Extender Universal Luggage Handle Extender filed on Mar. 20, 2006.

### BACKGROUND OF THE INVENTION

The present invention relates to a luggage handle extender that is universal to attach to any existing Pullman type luggage handle to extend the space between your leg and your luggage thus stopping the luggage from banging the back of your leg. Conventional luggage handles do not extend out far enough causing the luggage to bang the back of your leg while walking. Conventional luggage handles are not flexible and can twist your wrist while stepping on or off a curb. The Universal Luggage Handle Extender is flexible and will not twist your wrist and can be folded small enough to fit in a purse or pocket it also has a built in I.D. tag to prevent lost or misplaced luggage.

### BRIEF DESCRIPTION OF THE DRAWINGS

In the drawings:

FIG. 1 The clear plastic sleeve for the I.D. tag of the Universal Luggage Handle Extender

FIG. 2 Is the I.D. tag of the Universal Luggage Handle Extender

FIG. 3 The cut to length tubing used for the handle of the Universal Luggage Handle Extender

FIG. 4 The cut to length flexible strap of the Universal Luggage Handle Extender

### DETAIL DESCRIPTION OF THE PREFERRED EMBODIMENT

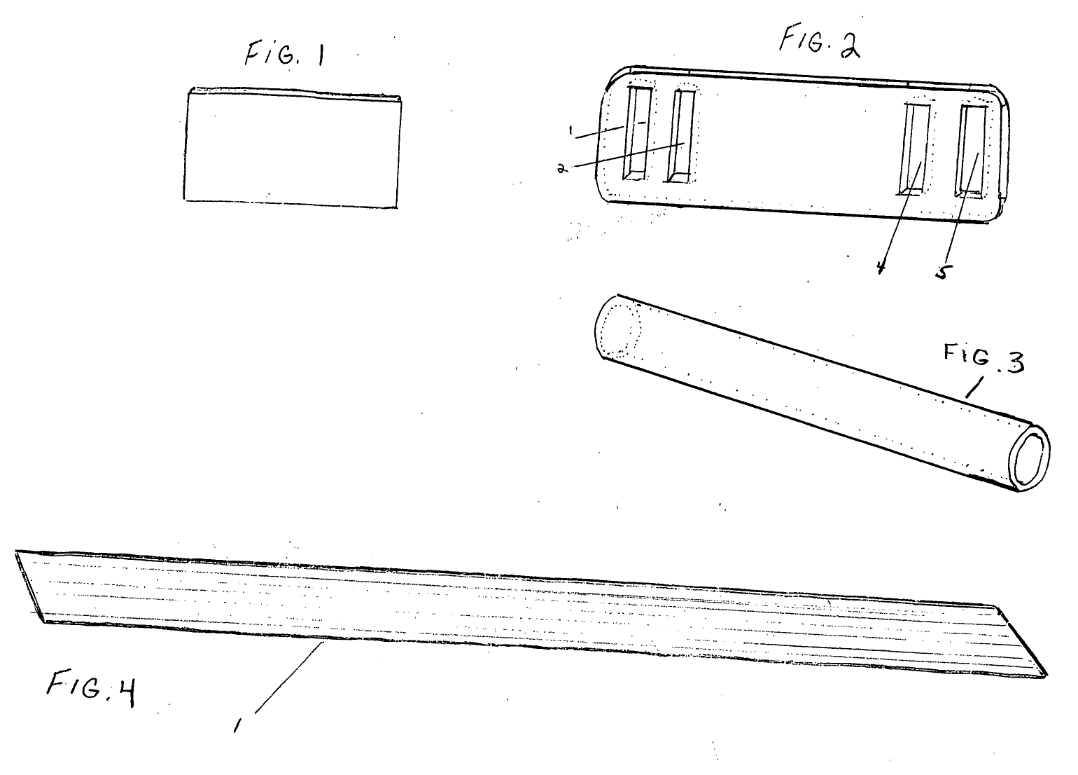

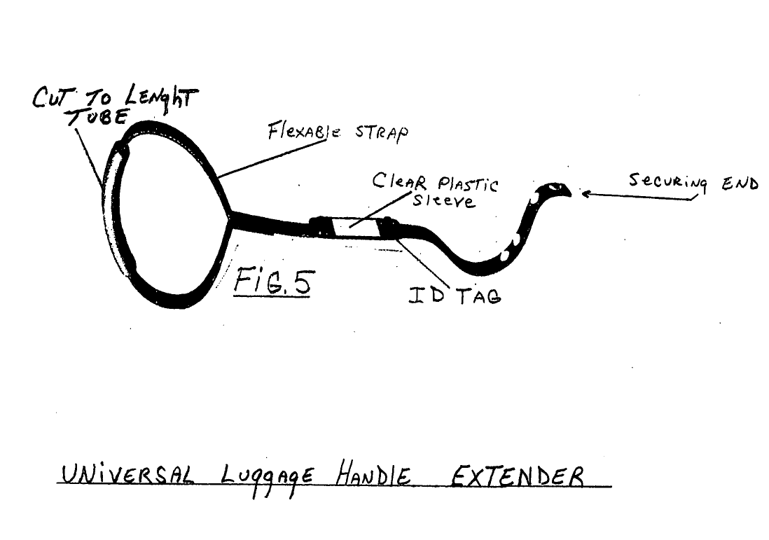

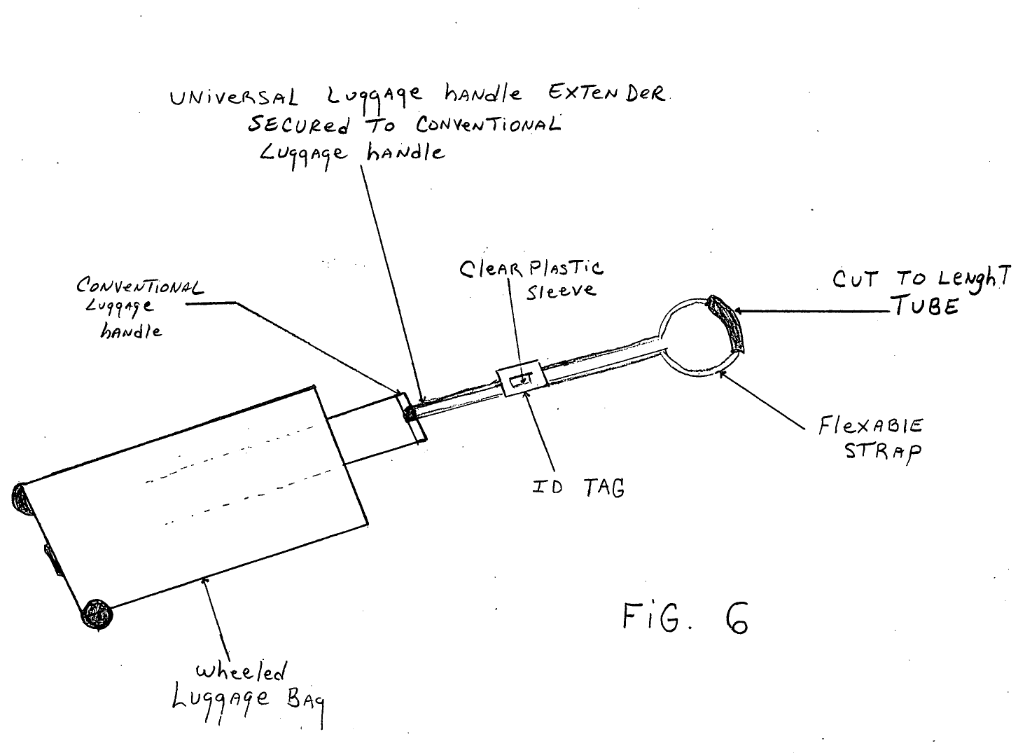

Referring initially to FIG. 1, 2, 3, and 4 of the present invention comprises the Universal Luggage Handle Extender FIG. 5. Including a clear plastic sleeve FIG. 1 an I.D. tag FIG. 2 a cut to length tube FIG. 3 and a flexible strap FIG. 4. The clear plastic sleeve FIG. 1 is secured permanently to the I.D. tag FIG. 2. The cut to length tube FIG. 3 is placed around the end of the flexible strap FIG. 4 the flexible strap is then looped and secured to form the handle of the Universal Luggage Handle Extender's handle FIG. 5. The flexible strap FIG. 4 is fed through the openings 1, 2, 4, and 5 of the I.D. tag FIG. 2. The securing end of the Universal Luggage Handle Extender FIG. 5 secures to any conventional luggage handle extending it making it impossible to bang your leg and, because of its flexibility it will never twist your wrist while going on or off a curb. Because of its flexibility it can be folded to be put in a purse or pocket. The Universal Luggage Handle Extender extends the length of conventional luggage handles and increases the distance between your leg and you luggage. Conventional luggage handles of the Pullman type do not allow enough distance between the luggage and your leg while walking, causing the luggage to bump the back of your leg. The Universal Luggage Handle Extender gives you more distance and more flexibility to handle your luggage safely. FIG. 6 shows the Universal Luggage Handle Extender secured to a conventional luggage handle of the Pullman type.

I claim:

1. A device for extending luggage handles.
A Universal Luggage Handle Extender.
Comprising: A clear plastic sleeve for placing personal I.D. information, an I.D. tag that is double slotted on each end, a cut to length tubing and a cut to length flexible strap. The clear plastic sleeve is placed on the I.D. tag permanently for personal I.D. information. The cut to length tubing is used for the handle of the Universal Luggage Handle Extender it is placed over the flexible strap and looped, then secured to form the handle of the Universal Luggage Handle Extender. The flexible strap is fed through the slots of the I.D. tag to secure the I.D. tag to the flexible strap. The securing end of the Universal Luggage Handle Extender is then secured to any conventional luggage handle to extend the length of the handle preventing it from banging the back of your leg and providing more flexibility.
